(19) United States
(12) Patent Application Publication
(10) Pub. No.: US 2025/0392223 A1
(43) Pub. Date: Dec. 25, 2025

(54) LOW-POWER SOLID-STATE TRANSFORMERS WITH SINGLE-DEVICE SWITCHING AND LOW-Q RESONANT NETWORKS

(71) Applicants: TRUSTEES OF DARTMOUTH COLLEGE, Hanover, NH (US); Enphase Energy, Inc., Fremont, CA (US)

(72) Inventors: Allen T. Nguyen, Lebanon, NH (US); Charles R. Sullivan, West Lebanon, NH (US); Michael Harrison, Fremont, CA (US)

(21) Appl. No.: 19/246,602

(22) Filed: Jun. 23, 2025

Related U.S. Application Data
(60) Provisional application No. 63/662,644, filed on Jun. 21, 2024.
(60) Provisional application No. 63/662,649, filed on Jun. 21, 2024.

(51) Int. Cl. H02M 3/335; H02M 1/00; H02M 1/38; H02M 3/00

(52) U.S. Cl. CPC H02M 3/33571; H02M 1/0032; H02M 1/0058; H02M 1/385; H02M 3/01

(57) ABSTRACT

A power converter (for example, an unregulated isolated DC-DC converter) and method that may account for low-Q resonant operation rather than conventional high-Q approximations. The converter may include primary and secondary half-bridge circuits coupled through a high-frequency transformer, with a resonant tank formed by transformer leakage inductance, parasitic resistance, and output capacitance. Time-domain analysis may model parasitic resistance effects, enabling accurate calculation of component values for achieving zero-voltage and zero-current switching. The methodology may minimize yearly average power loss (for example, rather than peak efficiency), making it particularly suitable for applications with intermittent loading such as line-frequency transformer replacements.

### CROSS-REFERENCE TO RELATED APPLICATIONS

This application claims priority to U.S. Provisional Application No. 63/662,644, filed on Jun. 21, 2024, now pending, and U.S. Provisional Application No. 63/662,649, filed on Jun. 21, 2024, now pending, the disclosures of which are incorporated herein by reference.

### STATEMENT REGARDING FEDERALLY SPONSORED RESEARCH

This invention was made with government support under contract no. 1822140 awarded by the National Science Foundation. The government has certain rights in the invention.

### FIELD OF THE DISCLOSURE

This disclosure relates to transformers for low power applications; and more particularly to low-power solid state transformers.

### BACKGROUND OF THE DISCLOSURE

Current low-power (30 VA-100 VA) line-frequency transformers (LPLFTs) have large weights, varied costs, show low full-load efficiencies, and incur large standby losses. This is particularly concerning because in many applications these transformers spend most of their load cycle in this standby mode. Improved designs are needed.

Low-power line-frequency transformers (LFTs) are widely used in applications such as heating, air conditioning, industrial control systems, and doorbells. However, these transformers suffer from high standby losses, low efficiencies, large sizes, and high costs. For example, typical Class 2 LFTs exhibit low average efficiencies and significant no-load power losses, especially since they are often connected to the line voltage continuously while supplying full-load power only intermittently.

Solid-state transformers (SSTs) offer a potential solution, with high-power prototypes (100+ kVA) demonstrating success. However, to compete with LFTs, low-power SSTs must be cost-effective, compact, and simple. Existing SST topologies often include regulation, sensing, or extremely high performance, that increases cost and complexity, which is unnecessary for many low-power LFT applications. Additionally, high-performance resonant designs, common in existing SST topologies, require high-Q components, increasing size and cost.

There is a need for power converters, such as low-power, unregulated converters that achieve high efficiency while reducing size and cost.

### BRIEF SUMMARY OF THE DISCLOSURE

The present disclosure provides topologies for power converters. For example, the present disclosure provides a resonant DCX transformer for the application of a low-power line-frequency transformer replacement. A lower-Q approximation of the time-domain analysis of the resonant tank is introduced, allowing designers to take full advantage of lower impedance components as is feasible in an unregulated isolated dc-dc converter. Volume or cost constrained designs that utilize lower-Q components can benefit from the analysis here to further reduce engineering prototyping time and increase model optimization accuracy.

A non-limiting example embodiment is 40 VA Class 2 LFT replacement in the form of a single-stage solid state transformer. This SST design requires minimal control overhead and is designed using an optimization model based on the yearly average power loss. The example SST's standby loss is 3.8% that of the Class 2 LFTs, and its yearly average standby loss is 5.9% of that of the LFTs.

The present disclosure provides a power converter with a high-frequency (HF) transformer, a primary bridge, and a secondary bridge forming a low-Q resonant tank. The resonant tank may be configured for soft switching, (e.g., including zero-voltage switching (ZVS) and/or zero-current switching (ZCS)). The converter may operate in a low-Q mode (e.g., Q<20) and may be optimized to minimize yearly average power loss based on a usage cycle, achieving high efficiency and low standby loss. The design is particularly suited for low-power applications, such as replacing Class 2 LFTs in ac-ac SSTs.

The disclosure includes a method for designing the converter, using a low-Q model to select the resonant capacitance and a particle swarm algorithm to optimize parameters, ensuring accurate ZCS and minimal power loss within volume constraints.

In one example, an unregulated isolated DC-DC converter is provided. The converter includes a primary half-bridge circuit, a secondary half-bridge circuit, and a high-frequency transformer. The converter operates in a low-Q resonant mode (e.g., where significant parasitic resistance effects may be accounted for in the design analysis).

In another aspect, the disclosure provides a method for optimizing such a converter. The method may include performing low-Q time-domain analysis of the resonant tank, calculating voltage differences based on periodic steady-state conditions, and optimizing parameters including switching frequency, transformer design, and output capacitance to minimize yearly average power loss.

Embodiments of the present disclosure may enable zero-voltage switching (ZVS) in the primary half-bridge and zero-current switching (ZCS) in the secondary half-bridge while operating with lower impedance passive components than would be possible with high-Q approximation methods.

### DESCRIPTION OF THE DRAWINGS

For a fuller understanding of the nature and objects of the disclosure, reference should be made to the following detailed description taken in conjunction with the accompanying drawings.

FIG. 1: Highlighted are different isolated converters that could take advantage of the analysis presented in this paper, specifically where regulation is not needed.

FIG. 2: (a) a DCX topology according to an embodiment of the present disclosure. (b) Half-cycle schematic of the resonant tank assuming Cᵢₙ is sufficiently large; this includes the voltage provided by the transformer, the leakage inductance (Lₗₖ), the lumped parasitic resistances (Rₚ), and one of the output capacitance's (Cₒᵤₜ)-(c) The full analysis is done on this simplified tank. (d) The resonant tank current waveform once the voltage difference is applied to the tank. A sinusoid is created if the resonant tank is high-Q. (e) As the Q is lowered, the current waveform deviates from the sinusoid; up to a point where a large current is still present during the switching transient.

FIG. 3: Time-domain output capacitor voltages of FIG. 2(a) is shown across several switching cycles. When the capacitors are in series with the output, there is a constant capacitor current, reducing the capacitor voltage. The resonant period is a result of ΔV placed across the other resonant components.

FIG. 4: Flow diagram of an iterative design process according to an embodiment of the present disclosure.

FIG. 5: Model set to the specified frequency then allowed to find the optimum design to minimize P_{Y}. Maximum variation from simulation is 12.1% at 1 MHz.

FIG. 6: Model set to the specified transformer turns then allowed to find the optimum design to minimize P_{Y}. Maximum variation from simulation is 11.5% at 15 turns.

FIG. 7: Resonant frequency output capacitance approximation (C_{freq}) vs model calculated output capacitance (C_{act}) at different values of Q.

FIG. 8: Switch size optimization for lowest P_{Y} across selected frequencies.

FIG. 9: Image of prototype.

FIG. 10: Efficiency of the prototype compared to the model and simulation results. Peak experimental efficiency is 99.1% at an output power of 24 W.

FIG. 11: Power loss of prototype compared to the model and simulation. There is close agreement across all power levels. The largest percent deviation is found at the standby condition, where the experimental converter achieves a standby loss of 162 mW, as compared to a model and simulation standby loss of 82.5 mW and 89.9 mW.

FIG. 12: P_{Y} of the experimental prototype compared to the model and simulation; the experimental results is within 21% of the model, and 13% of the simulation P_{Y} values.

FIG. 13: Estimated standby power loss breakdown

FIG. 14: Estimated full load power loss breakdown

FIG. 15: Prototype primary no-load current. Highlighted is the magnetizing current needed to achieve ZVS in the primary half bridge and the primary and secondary switch node voltages.

FIG. 16: Prototype secondary full-load current. Shown is the ZCS operation of the secondary half bridge.

FIG. 17: Secondary-side full-load current. Using the high-Q capacitance value does not achieve the desired ZCS operation.

FIG. 18: Secondary-side full-load current. Using the low-Q capacitance value achieves the desired ZCS operation and reduces ringing in the secondary side switching transient.

FIG. 19: Deadtime-adjusted resonant frequency output capacitance approximation (C_{freq,b}) vs model calculated output capacitance (C_{act}) at different values of Q.

FIG. 20: A chart showing a method according to another embodiment of the present disclosure.

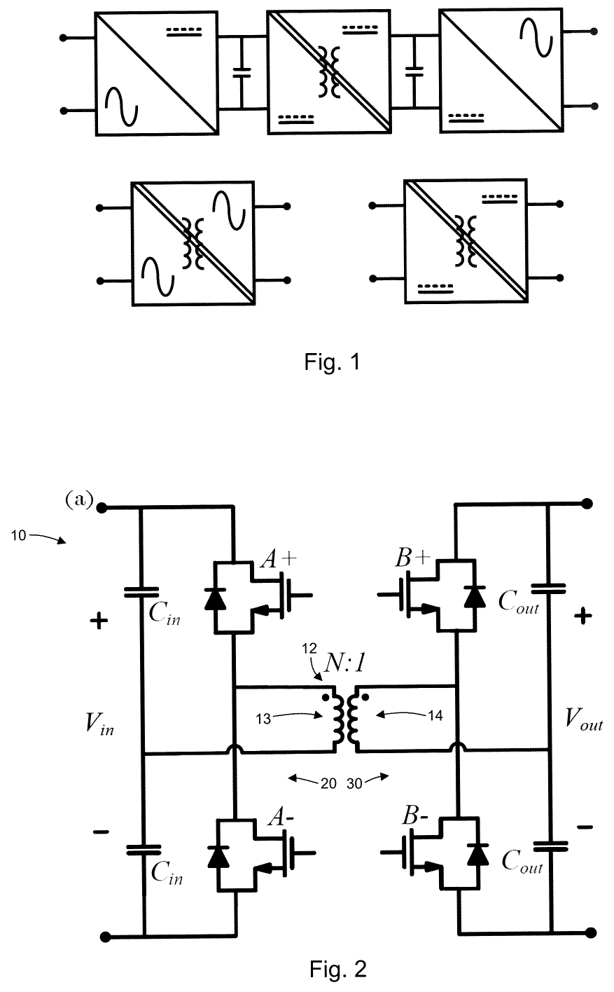

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure.

Embodiments disclosed herein are an electronic replacement for LPLFTs. LPLFTs are found in heating and ventilation control systems, doorbells, garage door openers, and other systems. The electronic replacement is in the form of an ac-to-ac isolated power converter known as a solid-state transformer (SST). A low-power SST alternative over the LPLFTs provides benefits such as lower weight, lower cost, higher efficiencies, and lower standby losses.

Topology for the embodiments disclosed herein includes a single-stage low-power SST. Two synchronous half bridges switching at a higher frequency (HF) are connected by a high-frequency transformer. The input half bridge can modulate the input line-frequency voltage waveform to a much higher frequency compared to the line frequency. This HF waveform is passed through a now much smaller volume transformer providing both the conversion ratio and the voltage isolation. The output half bridge reconstructs the HF voltage back into the line frequency. Each power switch in the half-bridge are two series opposing switching devices, which enables bidirectional voltage blocking. Topology for the embodiments disclosed herein can be operated in a resonant mode to achieve full soft switching of all actives, reducing losses especially during standby.

Embodiments disclosed herein provide single-device switching of the back-to-back bidirectional voltage switches and low quality factor design of the resonant operation. These improvements result in several advantages including increased robustness, reduced gate drive power losses, and cost-savings in the converter design.

In an embodiment, only one switch of the two series opposing power devices may be switching at high frequency while the other switch can be held on. Whether or not one switch is switching or left on is a function of the polarity of the input line frequency voltage, which may require input voltage sensing circuitry. However, this results in the following advantages. First, the body-diode-like behavior of the switching devices can now conduct, enabling it to control over voltages by diverting current to the input capacitor. Second, the body-diode-like conduction provides more leeway for any deadtime ringing or timing mismatches, increasing overall robustness. Third, since only one of the two devices is driven at high frequency, the gate drive power requirement is reduced by a factor of two, increasing the efficiency and decreasing standby losses.

Embodiments disclosed herein also enable lowering of the resonant tank quality factor (Q). Since the switching is synchronized, no large impedances are needed to buffer the voltage waveforms from the input to the output half bridges. Thus, the parasitic impedances of the HF transformer are enough to achieve the desired resonant operation. In some embodiments, the HF transformer can be designed for low parasitic resistance without design compromises sometimes used to increase its leakage inductance.

A previous design achieved a peak efficiency of 97.3% and a standby loss of 196 mW, compared to the LPLFT average values of 84.4% and 2.8 W. However, this design was found to be sensitive to line transients and acted more as a proof of concept. A prototype of an embodiment disclosed herein achieved higher efficiency and lower losses, while also providing increased robustness to line-transients.

Lower-Q operation is not intentionally utilized in SST work. Many high-power SSTs incorporate regulation features that are not needed in this application and would not work well with low-Q resonance. Additionally, the efficiency targets in high-power SSTs are higher, whereas embodiments disclosed herein provide low cost and robustness since adequate efficiency is easier to achieve.

Lossy low-power line-frequency transformers are common across several markets across the nation, including, for example, heating, ventilation, air conditioning systems, doorbells, and garage door openers. Manufacturers seek to reduce power losses because of pressure from both the public and private industry to meet a carbon neutral, low greenhouse emission target.

Embodiments disclosed herein provide a high-efficiency, robust, and a low-cost method/alternative to reduce standby power losses of these common low-power line-frequency transformers by over 15 90%. Thus, with the seemingly low-targets provided by the overall very low full-load and standby efficiencies inherent to these low-power transformers, an alternative can be designed to replace these LPLFTs. This is in contrast to their higher-power counterparts, namely line distribution transformers operating in the +100 kW regime, where any alternatives must meet high efficiency targets while maintaining high robustness standards.

In an aspect, the present disclosure provides a power converter (e.g., an unregulated isolated DC-DC converter, etc.) optimized for applications requiring minimal yearly average power consumption, such as replacements for low-power line-frequency transformers. Unlike prior art approaches that assume high-Q resonant operation, embodiments the present disclosure may explicitly account for parasitic resistance effects in a low-Q resonant tank, enabling more accurate design and optimization.

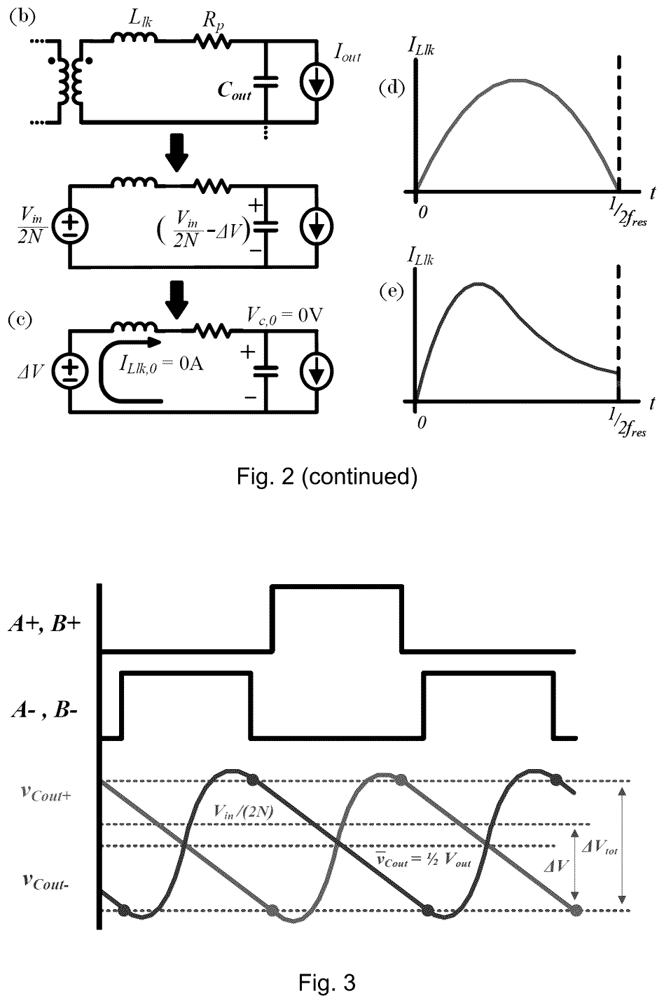

With reference to FIG. 2(a), in a first aspect, the present disclosure may be embodied as a power converter 10, such as, for example, a dc-dc converter, etc. The power converter 10 includes a high-frequency (HF) transformer 12 having a primary side 13 and a secondary side 14. An example of a suitable high frequency transformer may operate at frequencies significantly higher than standard 50/60 Hz line frequencies, such as, for example, in the range of 20 kHz to several MHz. A first bridge 20 is on the primary side 13 of the HF transformer 12 (including A⁺ and A⁻). The first bridge 20 has an input capacitance (Cᵢₙ). The first bridge may be, for example, a half bridge. A second bridge 30 is on the secondary side 14 of the HF transformer 12 (including B⁺ and B⁻). The second bridge may be, for example, a half bridge.

The power converter 10 has a resonant capacitance. For example, in some embodiments, the second bridge 30 may have a resonant capacitance. The resonant capacitance may be an output capacitance (Cₒᵤₜ) or a discrete capacitance (from, for example, a discrete series capacitor, etc.) In some embodiments, discrete capacitance may include, without limitation, parasitic capacitances (e.g., from switches, the transformer, etc.) The HF transformer, the first bridge, and the second bridge have a resonance, and the resonance and resonant capacitance are selected for soft switching (e.g., ZVS and ZCS operation)—the HF transformer, the first bridge, and the second bridge form a resonant tank, and the resonant tank and resonant capacitance are selected for soft switching. For example, soft switching may include at least one of zero-voltage switching (ZVS) or zero-current switching (ZCS). The power converter may be configured for zero-voltage switching in either the first bridge or the second bridge. The power converter may be configured for zero-current switching in either the first bridge or the second bridge. ZCS in the second bridge may be achieved by, for example, configuring the power converter to operate such that leakage current returns to zero at the end of each switching period.

The resonant tank may operate in a low-Q resonant mode with a quality factor Q less than 20 (e.g., where the quality factor Q is defined by a leakage inductance of the HF transformer, a resistance in series with the resonant tank, and the resonant capacitance).

In some embodiments, the HF transformer, the first bridge, and the second bridge may be selected so as to minimize yearly average power loss (P_{Y}). For example, the yearly average power loss may be minimized according to P_{Y}=P_{FL}Mₒₙ+P_{NL}(1−Mₒₙ), where P_{FL} is full-load power, Mₒₙ is a standby time-on ratio, and P_{NL} is no-load power. In some embodiments, the power converter (HF transformer, the first bridge, and the second bridge) has a switching frequency (f_{sw}), number of turns in a primary winding (Nₚᵣᵢ), and operating dead time (t_{d}), and each are selected to minimize P_{Y}. In some embodiments, a switch-size factor (S_{sw}) is selected to minimize P_{Y}. The optimization of P_{Y} may include estimating core loss of the HF transformer using Steinmetz parameters, and the core loss may be accounted for in both full-load and no-load conditions.

In another aspect. the present disclosure may be a solid-state transformer that includes a power converter according to an embodiment described herein. For example, the present disclosure may be embodied as an ac-ac solid-state transformer (SST) including the power converter described herein. The power converter may serve as an isolation stage operating at a peak dc line voltage derived from an ac input. Such an SST may be configured to replace a low-power line-frequency transformer.

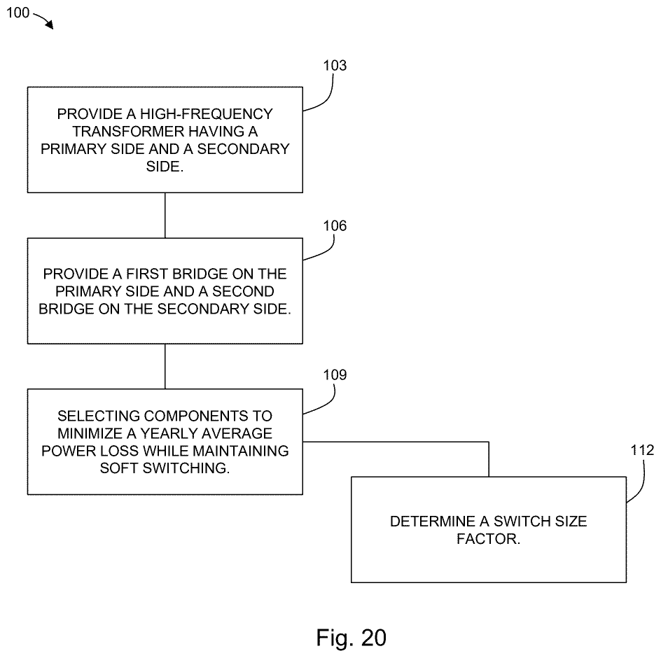

With reference to FIG. 20, in another aspect, the present disclosure may be embodied as a method 100 of designing a power converter (such as, for example, a dc-dc converter, an ac-ac converter, etc.) The method 100 includes providing 103 a high-frequency (HF) transformer having a primary side and a secondary side. A first bridge is provided 106 on the primary side of the HF transformer, and a second bridge is provided 106 on the secondary side of the HF transformer. In the method, a switching frequency (f_{sw}) of the converter, a number of turns in a primary winding (Nₚᵣᵢ) of the HF transformer, and operating dead time (t_{d}) of the converter are selected to minimize an average yearly power loss (P_{Y}) while maintaining soft-switching. For example, the method 100 may include selecting 109 the components (HF transformer, switches) such that a switching frequency (f_{sw}), number of turns in a primary winding (Nₚᵣᵢ), and operating dead time (t_{d}) so as to minimize an average yearly power loss (P_{Y}), while maintaining soft-switching (zero-voltage switching (ZVS) and zero-current switching (ZCS)). In some embodiments of the method, minimizing P_{Y} may include determining 112 a switch-size factor (S_{sw}). In some embodiments of the method, the yearly average power loss is minimized according to P_{Y}=P_{FL}Mₒₙ+P_{NL}(1−Mₒₙ), where P_{FL} is full-load power, Mₒₙ is a standby time-on ratio, and P_{NL} is no-load power.

The converter may operate at a fixed switching frequency f_{sw} with a fixed duty cycle of approximately 50%, reducing control complexity while achieving the desired conversion ratio through the transformer turns ratio N:1.

Unlike conventional resonant converter designs that assume high-Q operation (where parasitic resistance is neglected), embodiments of the present disclosure may model and account for low-Q conditions. In the low-Q regime addressed by this invention, Q may be less than 20, 15, or 10 (or more or less according to particular applications). This may allow the use of lower impedance passive components, which can reduce size and cost while the improved modeling accuracy ensures proper operation.

Embodiments of the disclosure may provide a systematic optimization methodology aimed at minimizing yearly average power loss P_{Y}, which may be calculated as P_{Y}=P_{FL}Mₒₙ+P_{NL}(1−Mₒₙ), where P_{FL} is full-load power, Mₒₙ is a standby time-on ratio, and P_{NL} is no-load power. This optimization approach recognizes that typical low-power applications may operate at full load only a small fraction of the time and considering the impact of standby power consumption on overall energy efficiency.

### EXAMPLE EMBODIMENT

Examples are presented to illustrate the present disclosure, including a prototype converter constructed according to an embodiment of the disclosure. The examples are not intended to be limiting in any manner.

Low-power line-frequency transformers (LFT) are still common in applications including heating, air conditioning, industrial control systems, doorbells, and more. However, these LFTs are large, have low average efficiencies, and high standby losses. In most applications, these transformers are connected to the line voltage continuously, and only supplying full-load power intermittently. Thus, there is a vast potential for energy savings if their standby losses were reduced. Isolated ac-ac switching power converters, also known as solid-state transformers (SSTs), are a potential solution, as high-power (100+ kVA) prototypes have been successful. However, to be a competitive replacement, the low-power SST alternative must be low cost, lower volume/weight, and low complexity. Fortunately, there are several opportunities that make this possible: there is no need for regulation, and current low-power LFTs have such low efficiency that it's easy to make a substantial improvement.

SSTs are commonly categorized based on the number of conversion stages, mainly from three to one. Three-stage SSTs (ac-dc-dc-ac) characteristically have the greatest number of components and complexity; however, they provide more features such as regulation and energy storage. Single-stage SSTs (ac-ac) typically offer higher efficiencies and power density, a byproduct of the reduced component count and complexity. However, without inherent energy storage, they can be more susceptible to line transients.

Some embodiments of the present disclosure use an unregulated dc-dc isolation stage. There are at least two scenarios in which this is applicable to SSTs: This isolation stage could serve as the dc-dc stage of a multi-stage SST or could represent a single-stage SST operating at the peak dc line voltage. In past literature, there are many different types of isolated dc-dc topologies that are used as the dedicated dc-dc stage of an SST, including LLC/resonant based and dual active bridge (DAB) based. Some designs use this stage for regulation and overall system control. However, in low-power LFT applications, there is no need for regulation. Opting for topologies with unregulated conversion leads to reduced complexity and energy storage requirements.

Single-stage SSTs indirectly benefit from the analysis presented here. Full optimization for an ac line cycle includes many other design considerations. However, designing for the peak of the line, assuming dc-dc operation, allows key design tradeoffs to be examined. The methods outlined can also be used for unregulated, isolated dc-dc converters, sometimes called DC-transformers or “DCX” stages.

The topology selected for this example embodiment and discussion is a common DCX design, shown in FIG. 2(a). The full description is in the following section. The topology includes pseudo-resonant operation in the secondary half-bridge used to achieve zero-current switching of the switches. In most analyses of this topology (and similar resonant DCX converters), designers assume that the resonant tank is high-Q, ignoring the series parasitic resistances. In the present disclosure, that assumption is addressed while providing equations and model results for designing in the low-Q realm. This represents an opportunity in unregulated converters that allows for more stringent size and cost constraints, while maximizing efficiency and reducing design iterations.

Section II will discuss the specific DCX topology in detail, specifically the low-Q time domain analysis. Section III will discuss the optimization workflow, and the free variables used to define a unique design. Section IV shows the optimization and model results, while Section V shows experimental results.

### II. Topology Overview

The example DCX topology analyzed in this paper is shown in FIG. 2(a). The switching is synchronized between the two half bridges at a fixed switching frequency (f_{sw}) and fixed duty cycle (50%), reducing the control complexity; while the conversion ratio is handled by the turns ratio of the high-frequency (HF) transformer. In addition to its low control complexity; the DCX can easily achieve full soft switching, reducing the overall no-load power loss. For the primary half bridge, zero-voltage switching (ZVS) is achieved by introducing a small deadtime (t_{d}) in conjunction with a finite magnetizing current. In the secondary half bridge, zero-current switching (ZCS) is achieved by operating at pseudo-resonance, allowing the leakage inductance of the transformer to shape the current through the secondary half bridge, bringing it close to zero before the switching transition, as shown in FIG. 2(d). The nature of a DCX converter means that the primary side switching voltage approximately matches the secondary side switching voltage; thus, any impedance needed to buffer the primary and secondary side voltage is small, and these component values can be small: we can use the leakage inductance of the transformer without compromising the efficiency of the transformer design to boost its leakage.

Thorough analysis of the DCX is found in the literature with several different variations on the topology, so we won't repeat a full analysis here. But some discussion is required on the high-Q approximation, or assuming that the series parasitic resistance Rₚ is negligible, that is common across prior work. Typically, with DCX converters operating in resonant mode, it is common to assume that the resonant tank is high-Q and to estimate component selection (or switching frequency) based on the resonant frequency. Then, when deviations arise in prototyping (such as not achieving ZCS at the designed frequency), designers have to either adjust operating frequency or passive component values to achieve full soft switching. The result is that the circuit is not operated as designed; and in some cases, the actual values of the tank passive components can vary greatly from the high-Q approximation. Without these changes, operating at the designed frequency results in partial hard switching, higher order harmonic peak currents, and higher current/voltage ringing during the actives' deadtime, reducing overall efficiency and increasing EMI, as shown in FIG. 2(e). Understanding the effects of a lower Q resonant tank can be beneficial to having a robust design while reducing prototype deviations, debugging, and overall design time. Also, starting the initial design with a low-Q assumption provides that the design optimization can be performed on a model that represents the real operation, allowing the optimization result to achieve higher efficiency in practice, compared to an optimization based on a less accurate model. This also allows designers to forgo ZVS or ZCS detection, snubber circuitry, or other hardware-based detection, reducing overall design complexity.

$${i}_{L} ( t ) = {e}^{- at} [ - {I}_{out} cos ( {w}_{q} t ) + \frac{\frac{ΔV}{{L}_{lk}} - {aI}_{out}}{{w}_{q}} sin ( {w}_{q} t ) ] + {I}_{out} \qquad ( 1 )$$

$${v}_{C} ( t ) = \frac{{e}^{- at}}{{C}_{out} {w}_{p}^{2}} [ ( \frac{{a}^{2} {I}_{o u t}}{{w}_{q}} - {I}_{out} {w}_{q} - \frac{a ΔV}{{L}_{lk} {w}_{q}} ) sin ( {w}_{q} t ) - ( \frac{ΔV}{{L}_{lk}} - 2 {aI}_{out} ) cos ( {w}_{q} t ) ] + ΔV - {I}_{out} {R}_{p} \qquad ( 2 )$$

$${v}_{C} ( 0 ) = {v}_{C} ( {T}_{0} = \frac{1}{2 {f}_{sw}} - {t}_{d} ) = {ΔV}_{tot} \qquad ( 3 )$$

$$ΔV = \frac{( {ΔV}_{tot} + {I}_{out} {R}_{p} ) ( {C}_{out} {w}_{p}^{2} ) {e}^{{aT}_{0}} - ( - {I}_{out} {w}_{q} + \frac{{a}^{2} {I}_{out}}{{w}_{q}} ) sin ( {w}_{q} {T}_{0} ) - 2 {aI}_{out} ( cos ( {w}_{q} {T}_{0} ) )}{( \frac{- a}{{L}_{lk} {w}_{q}} sin ( {w}_{q} {T}_{0} ) - \frac{cos ( {w}_{q} {T}_{0} )}{{L}_{lk}} + \frac{{e}^{{aT}_{0}}}{{L}_{lk}} )} \qquad ( 4 )$$

FIG. 2(b) shows a model for the simplified resonant tank operation; redrawing the resonant tank as FIG. 2(c) provides a model for the fundamental operation of the tank, allowing the following time-domain leakage current and capacitor voltage to be general across different topologies. Since analysis is on an unregulated converter and we don't assume the output voltage is known, the output is drawn as a current source. Note the inclusion of ΔV; this voltage is the difference between the transformer secondary side voltage and the output capacitor voltage right after the output capacitor is switched into the resonant tank. ΔV is the main cause of the resonant operation that occurs in the tank.

FIG. 3 shows intuitively where AV arises within the circuit analysis. Before switches A+ and B+ turn on, the voltage across the output capacitors is below their average value, due to the capacitor being in series with the output in its non-resonant phase. The total voltage difference in the non-resonant phase is

$${ΔV}_{tot} = {I}_{out} ( \frac{1}{2 {f}_{sw}} + {t}_{d} ) / {C}_{out} .$$

When switches A+ and B+ are on, the capacitor is forced in parallel with the resonant tank, where a voltage of Vᵢₙ/(2N) is applied to the tank. ΔV then is placed across the leakage inductor and resistor. The voltage difference ΔV is thus a function of the resonant operation of the tank and is not easily known.

We will show that by solving the periodic steady state equations, one is able to calculate this value accurately, as is needed for choosing the tank components.

The time-domain equations for FIG. 2(c) are written in terms of α=Rₚ/(2Lₜₖ), wₚ=\sqrt{LₗₖCₒᵤₜ}, and w_{q}=\sqrt{wₚ²−a²}. Note that the high-Q approximation equations, as used in prior literature, can also be obtained by setting Rₚ equal to zero. Periodic steady state must be maintained, so solving that the capacitor voltage to be equal in the resonant and non-resonant phases, one is able to solve for ΔV as a function of tank components.

### III. Optimization Workflow

The design of this converter may be optimized based on an objective of minimizing the yearly average power loss (P_{Y}). Typical low-power LFTs are only providing full-load power (P_{FL}) a minority of the year. Thus, no-load or standby power (P_{NL}) should be a priority when designing an ac-ac power electronic alternative. However, without understanding the exact full-load to standby time-on ratio (Mₒₙ), designers may opt to prioritize no-load efficiency at the expense of the full load. This may result in an overall yearly reduced efficiency than if they designed around the ratio Mₒₙ.

$${P}_{Y} = {P}_{FL} {M}_{on} + {P}_{NL} ( 1 - {M}_{on} ) \qquad ( 5 )$$

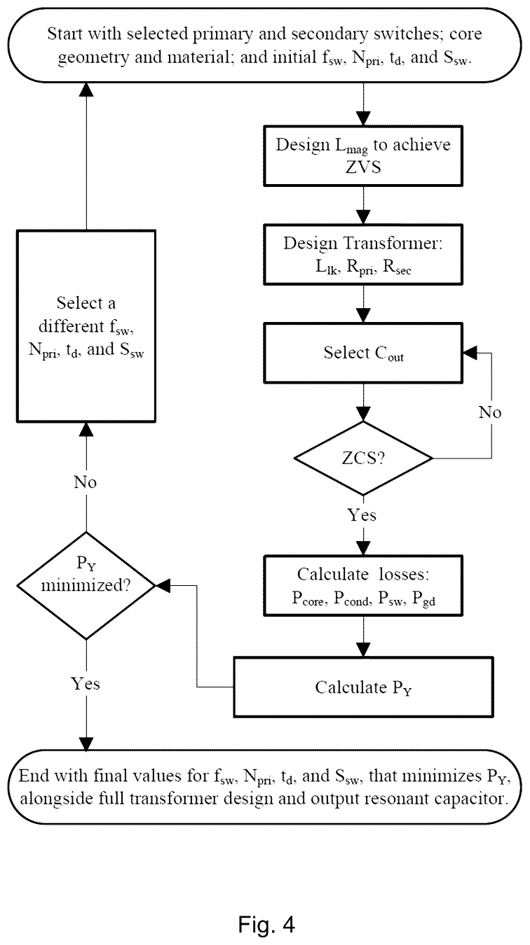

A goal of the optimization may be to produce a full DCX design, including operating switching frequency (f_{sw}), operating dead time (t_{d}), transformer design (Nₚᵣᵢ, L_{mag}, Lₗₖ), and an output (resonant) capacitance (Cₒᵤₜ) value that minimizes P_{Y} given a specific volume constraint. This constraint is to effectively size the HF transformer, limiting the optimization space. In practice, the HF transformer typically dominates the overall converter volume; thus, setting the transformer volume early in the design process can be a proxy for the overall solution cost. Also, given an initial power switch selection, we introduce an optimal switch size factor (S_{sw}) where the ideal switch area is a S_{sw} factor of the initial switch selection, under the assumption that capacitance scales linearly, and on-resistance inversely, with this factor. In some embodiments, the optimization process may be driven by a particle swarm algorithm. FIG. 4 shows the iterative design flow.

### A. Inputs

Throughout the optimization, there are several parameters that are kept constant; mainly the initial selected power switches, core material, and core geometry. These initial selections are mostly driven by desired solution volume and cost. P_{Y} generally can be reduced by decreasing the switch resistances, using a larger core, and/or selecting a higher performance core material, each of which has adverse effects on volume and cost. S_{sw} is an initial parameter that provides further optimization on cost of the actives, and similar metrics can be introduced to optimize on the volume and cost of the transformer.

The other input parameters, f_{sw}, Nₚᵣᵢ, t_{d}, and optionally S_{sw}, are optimized. This set of parameters also fully defines a unique design in conjunction with the fixed parameters. f_{sw} is the key variable that defines several aspects of the circuit operation, including all parameter values and losses. Nₚᵣᵢ directly influences the transformer design, including its leakage, winding loss, and core loss. The effect of the deadtime t_{d} is a bit subtle, as its main purpose is to ensure that ZVS is achieved in the primary half bridge, meaning that too small of a deadtime increases magnetizing current, in tum increasing P_{NL}. But, too long of a t_{d} affects circuit resonance, reducing the resonance period.

### B. General Workflow

The optimization workflow proceeds as follows:
1) Calculate L_{mag}:L_{mag} is calculated to satisfy the ZVS condition given the t_{d}, and the primary side output capacitance.
2) Design transformer: This step of the workflow is to calculate the transformer's winding resistance, leakage inductance, and core loss used for the following calculations. This step assumes a certain winding configuration and a selected litz wire strand diameter, both of which influence the winding resistance and leakage inductance. In this current model the winding configuration is barrel wound, single interleaved (P:S:S:P).
3) Calculate Cₒᵤₜ: Given the input parameters, Cₒᵤₜ is calculated with the condition to achieve ZCS in the secondary half bridge. In other words, solving the second periodic steady state condition that the leakage current is zero at the beginning and ending of the resonant operation.

$${i}_{L} ( 0 ) = {i}_{L} ( {T}_{0} = \frac{1}{2 {f}_{sw}} - {t}_{d} ) = 0 \qquad ( 6 )$$

Once the converter is operated in the ZCS condition, component selection then is not a function of output current, and ZCS is achieved for the entire load range. In the model, this is done numerically, by iteratively selecting Cₒᵤₜ to achieve a certain ΔV that will cause i_{L}(T₀) to be zero.
4) Calculate losses: Based on previous initial and calculated parameters, (1) allows us to accurately calculate the RMS currents within the converter, allowing for accurate conduction loss calculations in the full-load (P_{cond,fl}) condition, the no-load conduction loss (P_{cond,nl}) is assumed to be dominated by the magnetizing current. The core loss (P_{core}) is estimated through Steinmetz parameters and the transformer design. Switching loss is assumed to be zero. Lastly, gate drive (P_{gd}) loss is calculated based on the switches' input capacitance.
5) Calculate P_{Y}:P_{Y} can now be calculated where

$${P}_{FL} = {P}_{cond , fl} + {P}_{core} + {P}_{gd} \qquad ( 7 )$$

$${P}_{NL} = {P}_{cond , nl} + {P}_{core} + {P}_{gd} \qquad ( 8 )$$

and all other losses are assumed negligible or at least independent of the optimized parameters. This process is iterated through particle swarm optimization until P_{Y} is minimized.

### IV. Model Results

Given the application of replacing 40 VA Class 2 LFTs (120 to 24 Vᵣₘₛ, Mₒₙ of 0.284), we selected a PQ20/16 transformer core geometry and ML91S MnZn ferrite material from Proterial. The initial primary and secondary side switch selection is EPC 2050 and EPC 2619. With these parameters, the dc-dc, 170 V to 34 V (80 W), optimization results in a yearly average power loss of 198.3 mW at an optimum switching frequency of 336 kHz. As typical loaded operation is not at the maximum power capability, we have designated the full-load condition as 75% of the converters rated maximum load, in this case, 60 W.

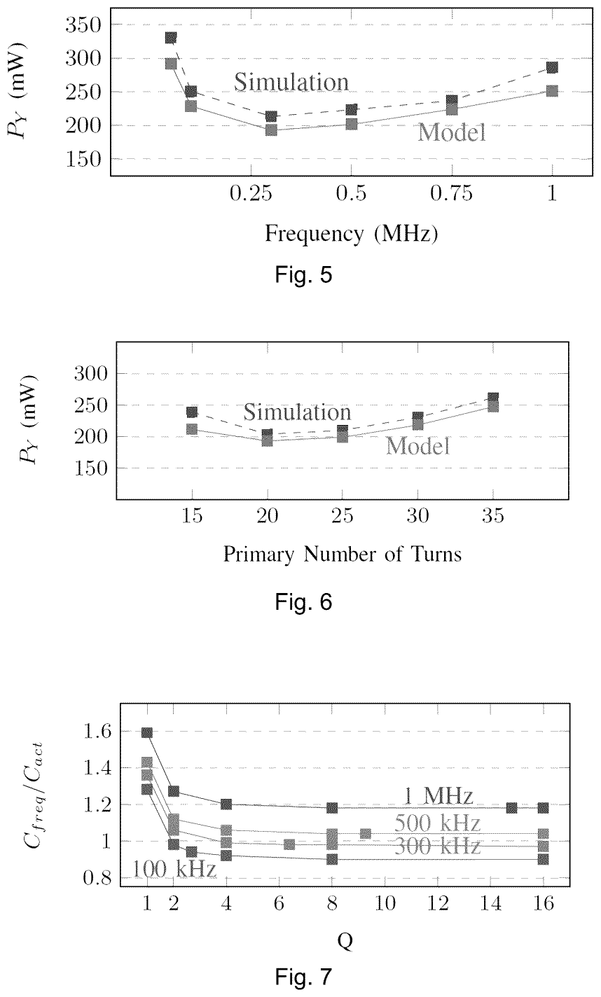

FIGS. 5-6 shows the verification of the model with respect to simulation. At each point of the figures, we allowed the optimization to find the minimum P_{Y} and the component values needed to achieve this minimum. These values were then inputs into a no-load and full-load simulation of FIG. 2(a), and the resulting P_{Y} of the simulation is graphed alongside the model results; the model is within 12.1% of the simulation results. The main discrepancy between the model and the simulations is the modeling of the GaN power switches and their parasitics; between the two, the simulation deadtime that accurately achieves ZVS is <20% of the model prediction of the optimum deadtime. While this might seem like a significant error, in practice, the deadtime can be tuned after the circuit is built and the impact on the optimized design and loss prediction is small.

FIG. 7 shows the amount of variation that would be seen on the output capacitance if one were to use the high-Q approximation (that resonance is

$${f}_{res , a} = \frac{1}{2 π \sqrt{2 {L}_{lkg} {C}_{out}}}$$

on different systems. Large discrepancies are shown, upwards of 60%, from the actual value of capacitance needed to achieve ZCS, especially at lower Q. Then as expected, at higher Q, the actual Cₒᵤₜ value needed to achieve ZCS is within ±20% of the high-Q approximation.

A version of this analysis, accounting for the deadtime's impact on the resonant period, is shown in the Appendix A.

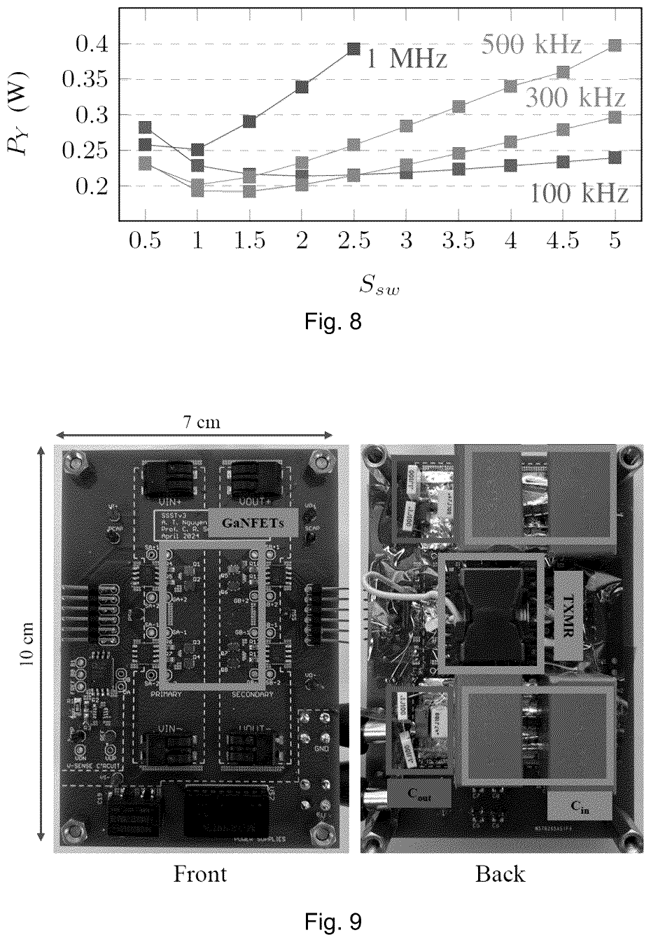

Lastly, we show the variation of the optimum P_{Y} as a function of switch size (S_{sw}) in FIG. 8. With full soft switching achieved in the optimized DCX, the optimization model tends towards larger switches up to a point where gate driving losses start to increase the loss. At 100 kHz, a switch twice the area reduces loss by 6%, and by 4% with a switch three times the area (gate driving losses start to impact the losses). At the higher frequencies, this benefit is less attractive. Similar to the volume constraint, the switch size is also a component of the cost, so it is up to the designer to decide if the reduction in losses is worth the increased cost. Doing a sweep with the model is relatively easy and can allow a designer to quickly decide if the selected switch results in the lowest overall power loss.

### V. Experimental Verification

Other than the optimal frequency, the model produced an interleaved transformer design, with 20 turns wound for the primary and 4 on the secondary. The wire selection is litz wire with 100 strands of AWG 46 for the primary and 500 strands of AWG 46 for the secondary. The target magnetizing inductance is 174.8 μH, the target leakage inductance is 65.85 nH, and the target output capacitance is 1.77 μF.

### A. Hardware Implementation

The model can be used in several different ways: to produce an optimum hardware design of which a designer attempts to imitate, to produce an optimum operating condition for a hardware design that is already completed, or in its basic form, to accurately predict the resonance capacitor. In our hardware implementation, we designed the prototype to be as close as possible to the model optimum. However, after experimentally measuring the transformer's parameters, we found that the experimental leakage of the hand-wound transformer was twice the desired leakage, and the experimental Rₚ was 1.5× the model output Rₚ, so the model was rerun with these updated values to recalculate the optimum output capacitance.

### B. Efficiency and Power Loss Results

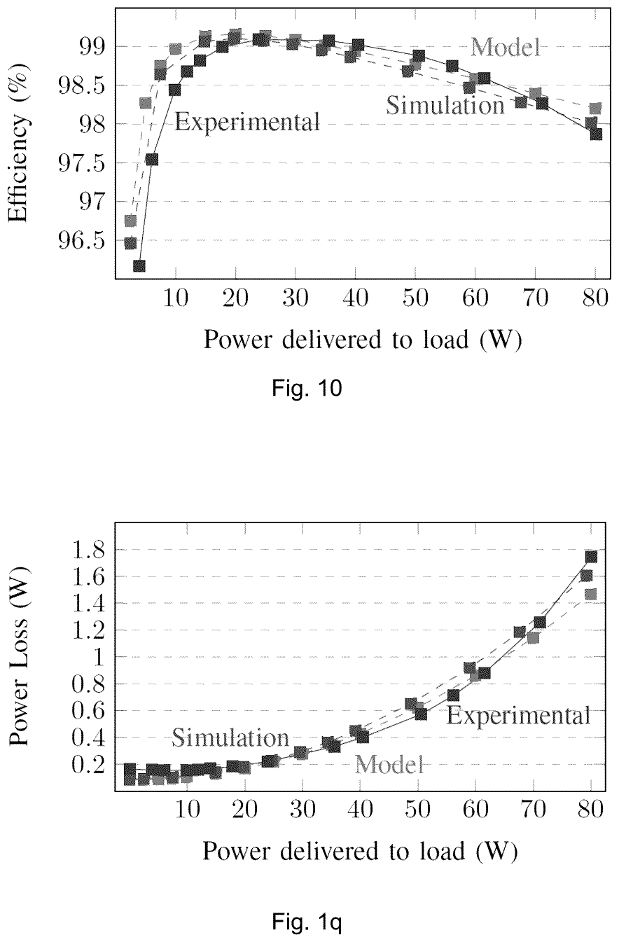

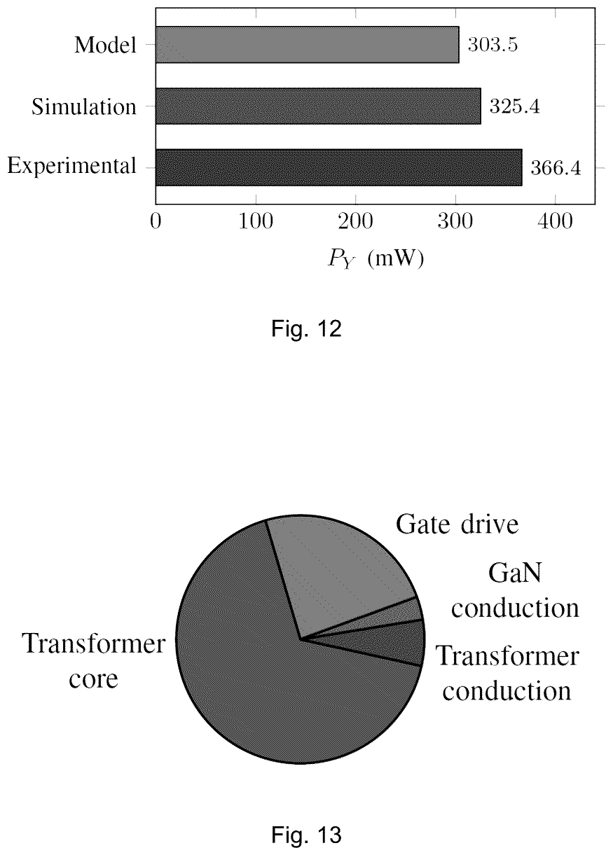

FIG. 10 shows the experimental results compared to simulation and the model. FIG. 11 shows the experimental power loss across all load ranges. Lastly, FIG. 12 shows the differences in measured P_{Y}.

The actual standby loss of the experimental converter is about twice that of the model and simulation; causing the main difference in the P_{Y} values between the experimental and model/simulation results. The main culprit for the differences is within the core loss model. We attribute this to the limited availability of core loss data for the selected core material ML91S. The manufacturer provides Steinmetz parameters for frequencies 500 kHz and above, but the circuit optimum using this data is below 500 kHz. Lower frequency core loss data or more advanced core loss modeling would allow for a more accurate optimization.

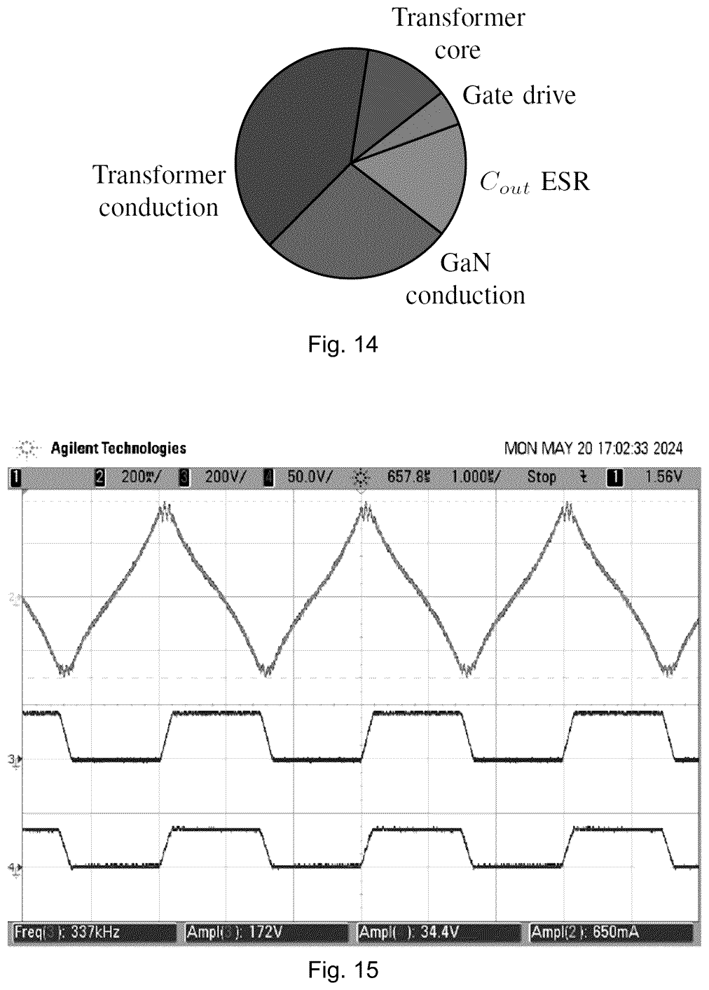

FIGS. 13 and 14 shows the estimated power loss breakdown of the converter at both no load and full load.

Since the output capacitors carry both the resonant current in one switching cycle and the output current in the other, they can incur large ESR losses as shown in FIG. 14. Reducing this loss could be done in two ways, selecting lower ESR but more expensive capacitors, or selecting Cₒᵤₜ such as a larger value such that it has lower ESR. The ability to use a larger capacitor with lower ESR is an advantage of designing around lower leakage inductance and consequently lower Q.

The model P_{Y} shown here is 1.5× the optimum possible P_{Y} estimated in Section IV. This is mainly due to experimental differences from the model including the increased Lₗₖ, Rₚ, and non-negligible Cₒᵤₜ ESR. But by updating the model with experimental parameters, the model is still able to accurately predict and match both simulation and experimental data.

### C. Experimental Waveforms

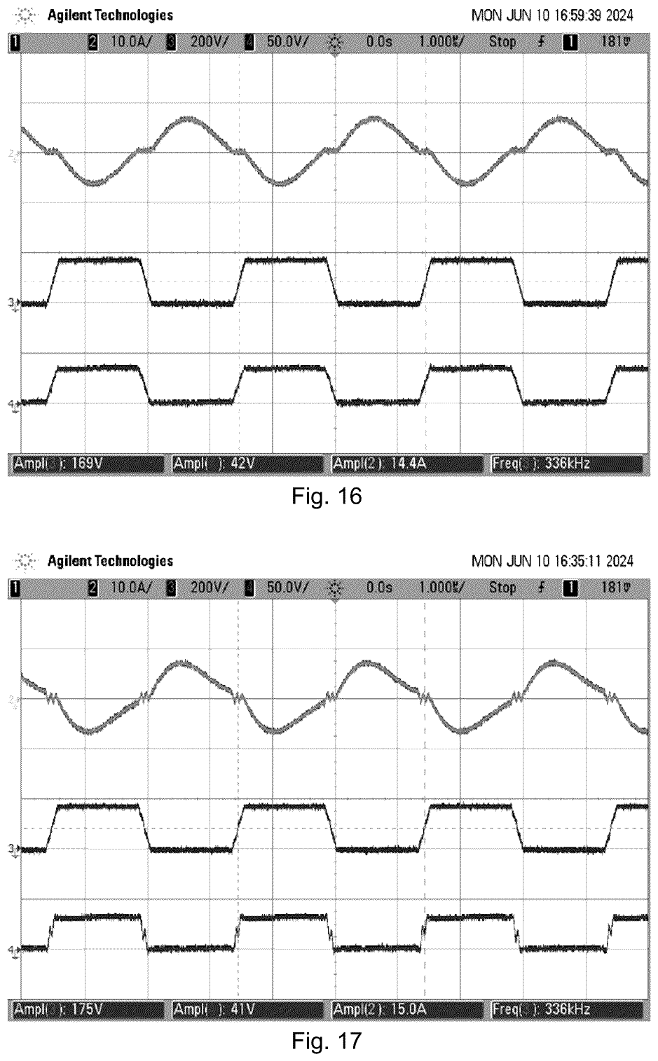

FIGS. 15 and 16 show switching nodes and inductor currents during no and full load; ZVS is achieved in both. FIG. 16 highlights ZCS.

### D. Low-Q Operation

The Q of the prototype resonant tank is 9.7, and its C_{freq}/Cₒᵤₜ ratio is 1. To further validate the model, we intentionally lowered the Q of the resonant converter by introducing a large discrete series resistor into the secondary side. This added 30 nH of additional leakage and 250 mΩ of series resistance, resulting in a Q of about 1.4.

A high-Q approximation would calculate the output capacitance to be 700 nF for full ZCS operation. However, using this capacitance value results in the secondary current waveform shown in FIG. 17; the resistor damps the waveform and the capacitance is too large to allow the leakage current to swing to zero.

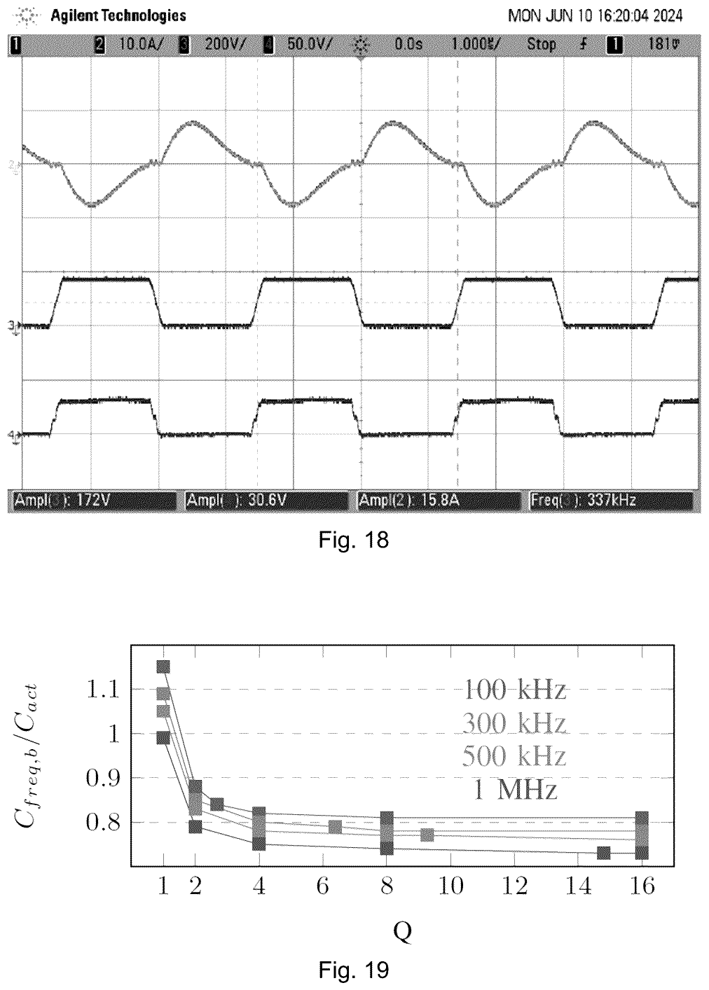

Applying the low-Q model, the capacitance value is shown to be 595 nF, 85% the high-Q approximation (C_{freq}/C_{act}=1.17, which is consistent with FIG. 7). Using this value results in full zero-current switching, as can be seen in FIG. 18.

### Appendix A—Additional Discussion on a Variation on the Definition for fᵣₑₛ

FIG. 7 assumes that designers decide that the resonant frequency is

$${f}_{res , a} = \frac{1}{2 π \sqrt{2 {L}_{lkg} {C}_{freq}}}$$

and design around that, while also showing that at higher Q the actual Cₒᵤₜ needed for ZCS is around ±20% of C_{freq}. However, with DCX designs, the deadtime is rarely negligible and, as explained in Section III, is typically long in order to reduce the magnetizing current and reduce P_{NL}.

Thus, a second-pass assumption would be to choose a resonant frequency to account for the non-negligible deadtime; essentially making the resonant period shorter and designing around that.

$${f}_{res , b} = {( \frac{1}{{f}_{sw}} - 2 {t}_{d} )}^{- 1} = \frac{1}{2 π \sqrt{2 {L}_{lkg} {C}_{freq , b}}} \qquad ( 9 )$$

Now, doing the same analysis as FIG. 7 but with C_{freq,b}, we get the capacitance adjustment factor as plotted in FIG. 19.

This analysis tightens the different frequency curves closer as compared to FIG. 7, but more importantly, it indicates significant differences when deadtime is considered. This further motivates the development of an accurate model to reduce design time especially for ZCS-based resonant converters.

Although the present disclosure has been described with respect to one or more particular embodiments, it will be understood that other embodiments of the present disclosure may be made without departing from the scope of the present disclosure. As used herein, the term ‘minimize’ means to reduce to a relatively small amount, degree, or value, and does not necessarily require optimization to an absolute minimum or global minimum value.

We claim:

1. A power converter, comprising:
a high-frequency (HF) transformer having a primary side and a secondary side;
a first bridge on the primary side of the HF transformer;
a second bridge on the secondary side of the HF transformer;
wherein the power converter has a resonant capacitance; and
wherein the HF transformer, the first bridge, and the second bridge form a resonant tank, and the resonant tank and resonant capacitance are selected for soft switching.

2. The power converter of claim 1, wherein the resonant tank operates in a low-Q resonant mode with a quality factor Q less than 20, the quality factor Q being defined by a leakage inductance of the HF transformer, a resistance in series with the resonant tank, and the resonant capacitance.

3. The power converter of claim 1, wherein the power converter is configured for zero-voltage switching in either the first bridge or the second bridge and zero-current switching in either the first bridge or the second bridge.

4. The power converter of claim 3, wherein zero-current switching is achieved by configuring the power converter to operate such that leakage current returns to zero at the end of each switching period.

5. The power converter of claim 1, wherein the resonant capacitance is an output capacitance or a discrete capacitance.

6. The power converter of claim 1, wherein the HF transformer, the first bridge, and the second bridge are selected so as to minimize yearly average power loss (P_{Y}).

7. The power converter of claim 6, wherein the yearly average power loss is minimized according to P_{Y}=P_{FL}Mₒₙ+P_{NL}(1−Mₒₙ), where P_{FL} is full-load power, Mₒₙ is a standby time-on ratio, and P_{NL} is no-load power.

8. The power converter of claim 6, wherein the power converter has a switching frequency (f_{sw}), a number of turns in a primary winding (Nₚᵣᵢ), and an operating dead time (t_{d}), and each of the switching frequency, the number of turns in a primary winding, and the operating dead time is selected to minimize P_{Y}.

9. The power converter of claim 8, wherein a switch-size factor (S_{sw}) is selected to minimize P_{Y}.

10. The power converter of claim 6, wherein the optimization of P_{Y} includes estimating core loss of the HF transformer using Steinmetz parameters, and the core loss is accounted for in both full-load and no-load conditions.

11. The power converter of claim 1, wherein each of the first bridge and the second bridge are half-bridges.

12. The power converter of claim 1, wherein the power converter is an unregulated converter configured to operate without active regulation of output voltage or current.

11. A solid-state transformer comprising a power converter according to any one of claims 1-10.

10. A method of designing a power converter, comprising:
providing a high-frequency (HF) transformer with a primary side and a secondary side;
providing a first bridge on the primary side and a second bridge on the secondary side, the second bridge including a resonant capacitance; and
wherein a switching frequency (f_{sw}) of the converter, a number of turns in a primary winding (Nₚᵣᵢ) of the HF transformer, and operating dead time (t_{d}) of the converter are selected to minimize an average yearly power loss (P_{Y}) while maintaining soft-switching.

11. The method of claim 10, wherein minimizing P_{Y} includes determining a switch-size factor (S_{sw}).

12. The method of claim 10, wherein the yearly average power loss is minimized according to P_{Y}=P_{FL}Mₒₙ+P_{NL}(1−Mₒₙ), where P_{FL} is full-load power, Mₒₙ is a standby time-on ratio, and P_{NL} is no-load power.
